(19) United States
(12) Patent Application Publication
(10) Pub. No.: US 2005/0031242 A1
(43) Pub. Date: Feb. 10, 2005

(54) Roller and cage assembly

(75) Inventors: David R. Torlai, Torrington, CT (US); Joseph F. Kenney JR., Winsted, CT (US)

Correspondence Address: MICHAEL BEST & FRIEDRICH, LLP, 100 E WISCONSIN AVENUE, MILWAUKEE, WI, 53202, US

(73) Assignee: Timken US Corporation, Torrington, CT (US)

(21) Appl. No.: 10/878,445

(22) Filed: Jun. 28, 2004

Related U.S. Application Data
(60) Provisional application No. 60/483,580, filed on Jun. 26, 2003.

(51) Int. Cl. F16C 33/48

(52) U.S. Cl. 384/572

(57) ABSTRACT

A roller and cage assembly comprising a base surface having an inner circumferential edge and an outer circumferential edge. A plurality of inner wall segments extending from the inner circumferential edge with an opening provided between adjacent inner wall segments. A plurality of outer wall segments extending from the outer circumferential edge with an opening provided between adjacent outer wall segments. The inner and outer wall segments extend perpendicular to the base surface with the respective inner and outer openings aligned to define roller pockets positioned between the inner and outer wall segments. A plurality of rollers are positioned in the roller pockets. A plurality of retention tabs extend from the inner or outer wall segments parallel to the base and are aligned with the roller pockets such that the tabs axially retain the rollers.

This application claims the benefit of U.S. Provisional Application No. 60/483,580 filed on Jun. 26, 2003.

### BACKGROUND

The present invention relates to bearings and particularly to bearings having rollers contained within a cage assembly.

Typical bearings include a two-part retainer or cage assembly as shown in FIG. 2, which is a cross-sectional view of the roller and cage assembly of FIG. 1 taken along line 2-2 of FIG. 1. A typical roller and cage assembly 100 as shown in FIGS. 1 and 2 includes a plurality of rollers A retained between first and second retainer portions B and C. Each retainer portion B, C must be stamped or formed, the rollers A aligned in one of the retainer portions B and the other retainer portion C thereafter connected to the first retainer portion B, which generally results in a complex and costly procedure.

Other conventional bearing-retaining assemblies include a “sigma-type” cage 110 as shown in FIG. 3. The cage 110 must be stamped from a strip and then the ends of the strip must be joined. Again, a complex and costly procedure. Additionally, the sigma-type cages 110 generally require areas of greater thickness 112 at the axial ends thereof, thereby increasing the axial space required for the bearing.

### SUMMARY

A roller and cage assembly that minimizes the number of parts and complexity of the retaining assembly would be welcomed by users of such bearings.

According to the present invention, a bearing assembly includes a retainer or cage assembly wherein an outer or inner circumferential wall of the retainer includes a tab portion integrally formed with the inner or outer circumferential wall that retains a roller of the plurality of rollers in axial position within the retainer or cage assembly. Other features integrally formed with the inner and outer circumferential walls of the retainer retain the roller in its radial position.

Additional features and advantages of the invention will become apparent to those skilled in the art upon consideration of the following detailed description exemplifying the best mode of carrying out the invention as presently perceived.

### BRIEF DESCRIPTION OF THE DRAWINGS

The detailed description particularly refers to the accompanying figures in which:

FIG. 1 is a plan view of a prior art roller and cage assembly;

FIG. 2 is a cross-sectional view of the roller and cage assembly of FIG. 1 taken along line 2-2 of FIG. 1;

FIG. 3 is an isometric view of a “sigma-type” cage of a prior art roller and cage assembly;

FIG. 4 is an isometric view of a roller and cage assembly in accordance with the present invention, showing a plurality of rollers retained by retention tabs integrally formed with an outer circumferential wall of a retainer;

FIG. 5 is a plan view of the roller and cage assembly of FIG. 4;

FIG. 6 is a cross-sectional view of the roller and cage assembly taken along the line 6-6 of FIG. 4;

FIG. 7 is a plan view of a stamped plate utilized to form the cage of FIG. 4.

FIG. 8 is a partial view of a roller and cage assembly according to the present invention showing an alternative configuration of a retention tab;

FIG. 9 is a partial view of a roller and cage assembly according to the present invention showing still another alternative configuration of a retention tab;

FIG. 10 is a partial view of a roller and cage assembly according to the present invention showing yet another alternative configuration of a retention tab;

FIG. 11 is another configuration of an inner and outer circumferential wall of a roller and cage assembly according to the present invention;

FIG. 12 is still another configuration of an inner and outer circumferential wall of a roller and cage assembly according to the present invention;

FIG. 13 is a plan and side view of a configuration of a retention tab according to the present invention; and

FIG. 14 is a plan and side view of still another configuration of a retention tab according to the present invention.

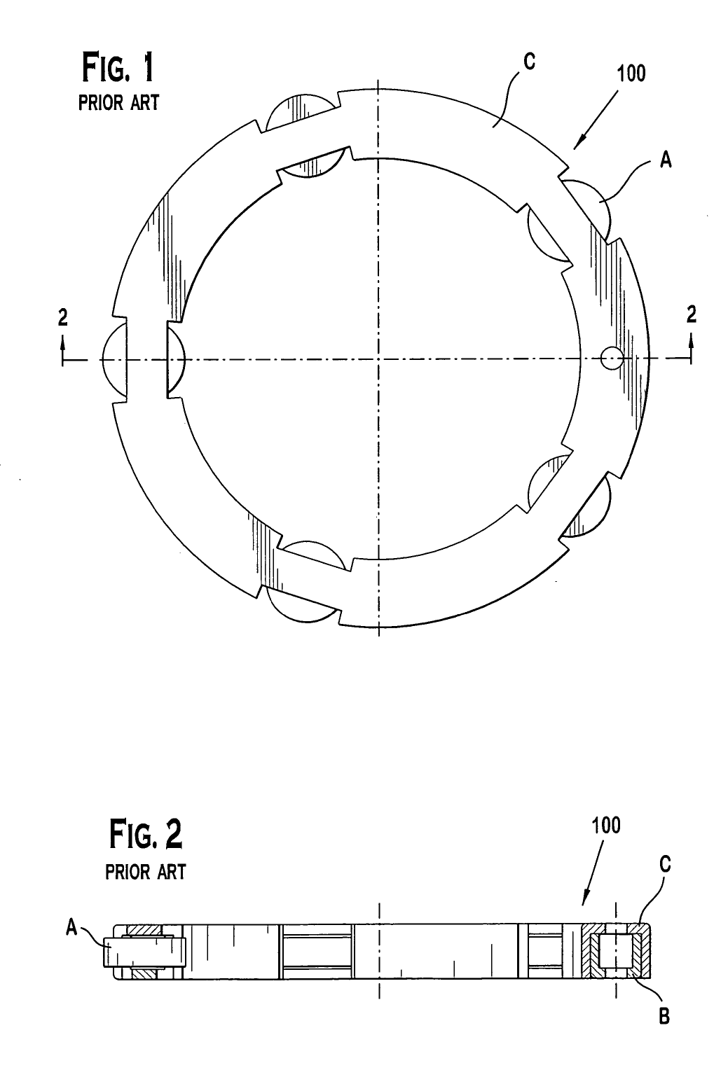

### DETAILED DESCRIPTION OF THE PREFERRED EMBODIMENTS

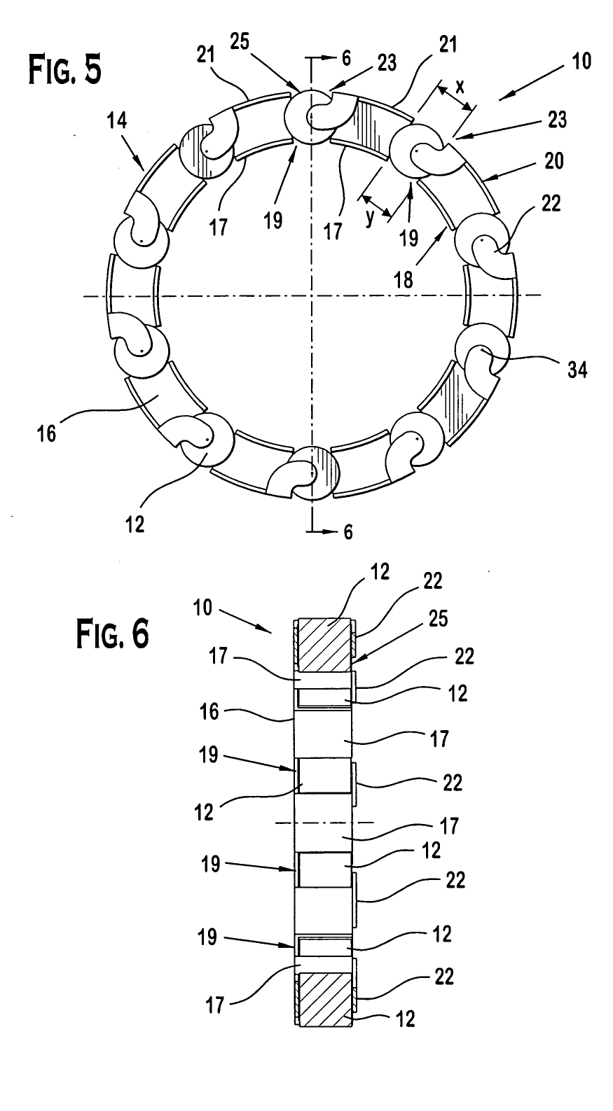

Referring to FIGS. 4-6, a roller and cage assembly 10 according to a first embodiment of the present invention is shown. The roller and cage assembly 10 includes a plurality of rollers 12 retained within a retainer or cage 14. The retainer or cage 14 is constructed of a single, stamped piece of low-carbon steel formed to include a base 16, an inner circumferential wall 18 and an outer circumferential wall 20. The base 16 is preferably defined by a continuous ring. The inner circumferential wall 18 is defined by a plurality of inner circumferential wall segments 17 extending from an inner circumferential edge of the base 16 with openings 19 between adjacent wall segments 17. The outer circumferential wall 20 is defined by a plurality of outer circumferential wall segments 21 extending from an outer circumferential edge of the base 16 with openings 23 between adjacent wall segments 21. The inner and outer wall segments 17 and 21 are preferably formed integral with the base 16 and are bent or otherwise formed such that the inner and outer wall segments 17 and 21 extend substantially perpendicular to the base 16 with the inner and outer openings 19 and 23 aligned to define roller pockets 25. As shown in FIG. 5, the width X of the outer circumferential wall openings 23 and the width Y of the inner circumferential wall openings 19 are sized to be less than the diameter of the rollers 12 such that the rollers 12 are retained radially.

The cage 14 further includes a series of tabs 22 stemming from various sections of the inner or outer circumferential walls 18, 20. In the present embodiment, a tab 22 extends from each one of the outer wall segments 21. The tabs 22 are preferably formed integral with the wall segments 21 and are bent or folded relative to the outer circumferential wall segments 22 so that they lie in a plane substantially parallel to the plane of the base 16. The tabs 22, on one side, and the base 16, on the other side, thereby retain the rollers 12 axially. Each of the tabs 22 in the present embodiment extends from a respective one of the outer wall segments 21, however, the tabs 22 may extend also extend from the inner wall segments 17, alone or in addition to tabs 22 extending from the outer wall segments 21.

Referring to FIGS. 4-6, each tab 22 preferably includes a slight inward dimple 34 to provide point contact with an end of the roller 12 to decrease friction and aid in the rolling action of the roller 12. The dimple 34 is positioned at the end of the tab 22 to approximately contact the center of the roller 12. The cage base 16 also preferably has inward dimples 35 (see FIG. 7) to provide point contact with the ends of the rollers 12 to decrease friction and aid in the rolling action of the rollers 12. The dimples 35 preferably align with the dimples 34 and are positioned such that the dimples 34 and 35 contact the rollers along their central axes. FIG. 13 shows a side view of the tab 22 and illustrates a possible configuration for the dimple 34. Alternatively, as shown in FIG. 14, the dimple 34 may be surrounded by a raised bead 36, which defines a plane along with other raised beads surrounding other dimples 34 on other tabs 22 to create a flat planar surface for a raceway used in conjunction with the roller and cage assembly 10 to roll on and generally give guidance to the cage 14. Again, as shown in FIGS. 13 and 14, dimple 34 (and in the case of FIG. 14, the bead 36) is a simple feature formed from a flat piece of material that is bent to produce the retainer 14.

Referring to FIG. 7, the cage 14 of the present invention is preferably stamped from a single flat sheet of the desired material, for example, low-carbon steel. The sheet is stamped with the inner wall segments 17 extending from the inner circumferential edge IE of the base 16 and the outer wall segments 21 extending from the outer circumferential edge OE of the base 16. The tabs 22 extend from respective ones of the outer wall segments 21. As explained above, the tabs 22 can extend from either the inner or outer wall segments 17, 21, or from both. The dimples 34 and 35 are easily formed in the tabs 22 and base 16 during stamping. The dashed lines in FIG. 7 illustrate the bend lines for the various components. The inner and outer wall segments 17, 21 are preferably bent perpendicular to the base 16 at the same time, for example, in a single drawing process. After the rollers 12 are loaded in to the pockets 25 defined by the aligned openings 19, 23, the tabs 22 are folded over to retain the rollers 12. As will be readily apparent to those of ordinary skill in the art, the precise shapes and sizes of the base 16, wall segments 17 and 21, and tabs 22 and the material out of which the retainer 14 and rollers 12 are formed can vary according to the present invention.

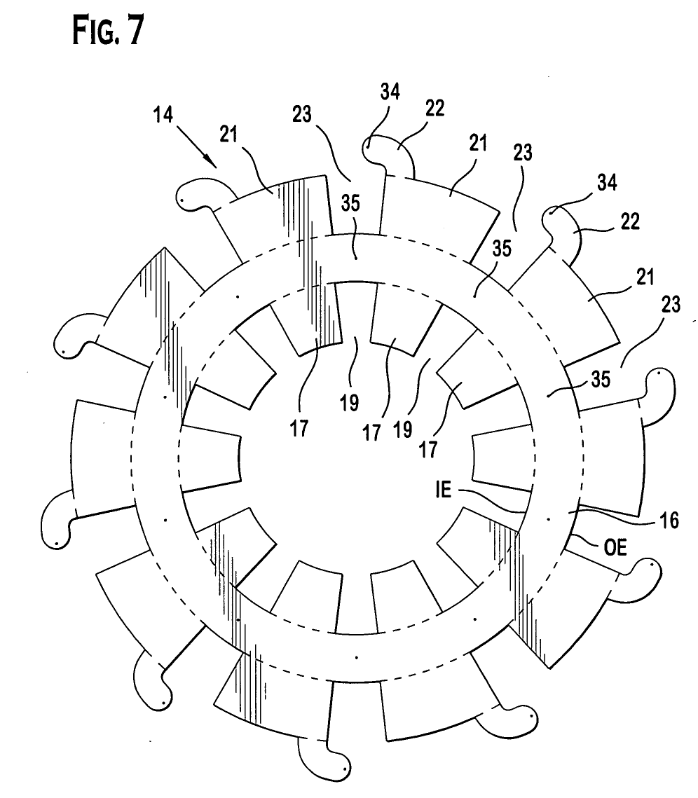

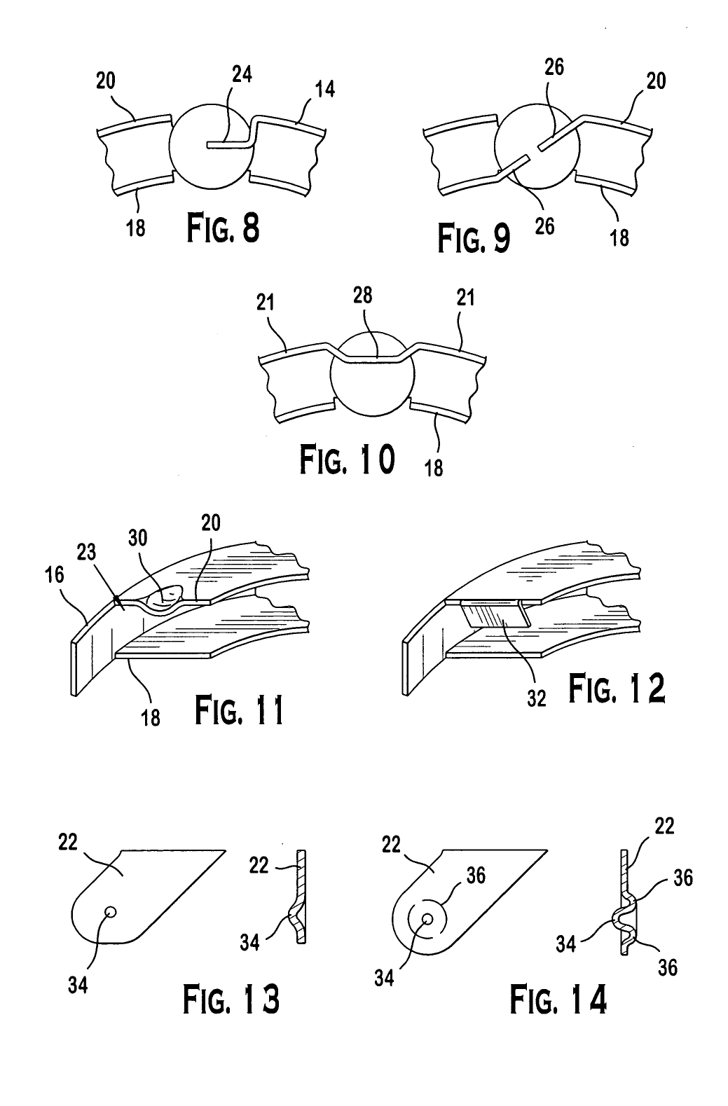

The tabs 22 may be formed in any of a number of configurations other than that shown in FIGS. 4, 5 and 6. For example, as shown in FIG. 8, a tab 24 may have a simple, angular configuration. As shown in FIG. 9, a tab 26 may be a simple, angled tab and may project from either the inner circumferential wall 18 or the outer circumferential wall 20. As shown in FIG. 10, a retention tab 28 may be a continuous link connecting consecutive outer circumferential wall segments 21. In all cases, a retention tab according to the present invention may extend from either the inner circumferential wall 18, the outer circumferential wall 20, or both. Additionally, whatever configuration a retention tab takes, it can be stamped so as to be integrally formed with either the inner or outer circumferential wall and later bent or folded relative to the inner or outer circumferential wall to axially-retain the roller 12 in the cage assembly 14.

In addition, the inner or outer circumferential wall 18, 20 may be bent or shaped to give further guidance or provide a bearing surface for a roller 12 retained within the cage assembly 14. For example, as shown in FIG. 11, the outer circumferential wall 20 includes an indentation or depression 30 adjacent to opening 23 to provide guidance for the roller 12 in the retainer 14. Again, alternatively, either the inner or outer circumferential walls 18 and 20, or both, can include the indentation or depression 30.

As shown in FIG. 12, the outer circumferential wall 20 of the cage 14 can include an additional folded guidance flap 32 adjacent to opening 23 that provides a bearing surface for the roller 12. Again, in all cases, features such as the flap 32 and depression 30 can be formed on the inner or outer circumferential walls 18 or 20, or both.

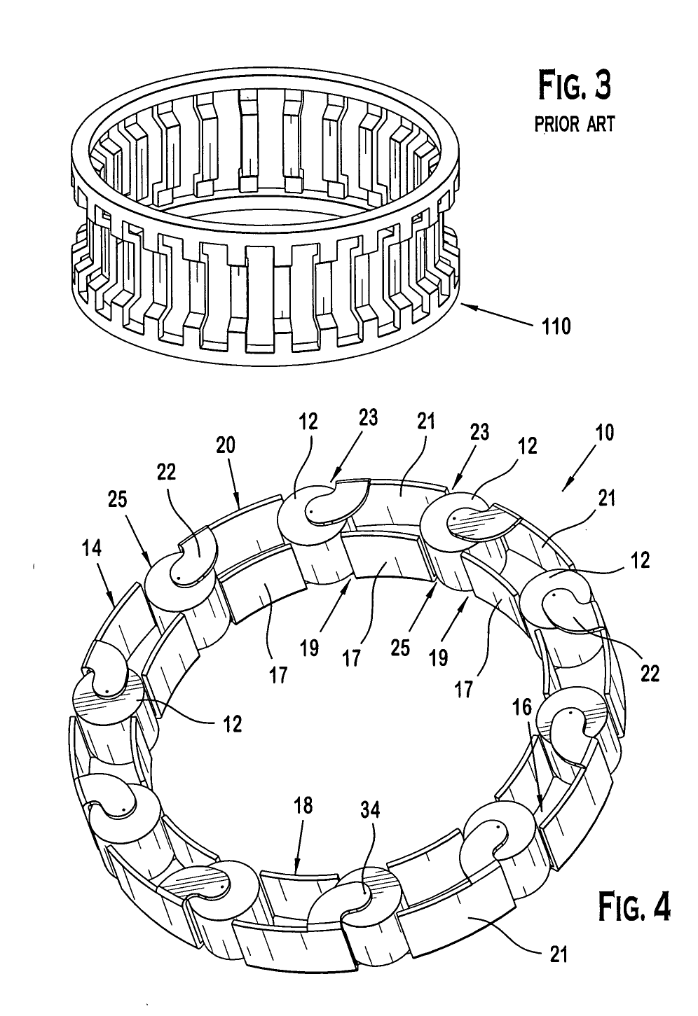

Further, the roller and cage assembly (10) has a minimal axial thickness as compared to sigma-type cages as shown in FIG. 3. The construction of sigma-type cages, as shown in FIG. 3, require areas of greater thickness than does the piece of stamped steel used in the retainer (14) of the roller and cage assembly (10) of the present invention.

Although the invention has been described in detail with reference to certain preferred embodiments, variations and modifications exist within the scope and spirit of the invention as described and defined in the following claim.

1. A roller and cage assembly comprising:
a base surface having an inner circumferential edge and an outer circumferential edge;
a plurality of inner wall segments extending from the inner circumferential edge with an opening provided between adjacent inner wall segments;
a plurality of outer wall segments extending from the outer circumferential edge with an opening provided between adjacent outer wall segments;
the inner and outer wall segments extending substantially perpendicular to the base surface with the respective inner and outer openings aligned to define roller pockets positioned between the inner and outer wall segments;
a plurality of rollers positioned in the roller pockets; and
a plurality of retention tabs extending from the inner or outer wall segments opposed to the base and aligned with the roller pockets such that the tabs axially retain the rollers.

2. The roller and cage assembly of claim 1 wherein the base surface is defined by a continuous ring.

3. The roller and cage assembly of claim 1 wherein the rollers have a given diameter and the inner and outer openings each have a width less than the given diameter.

4. The roller and cage assembly of claim 1 wherein each retention tab extends from a respective outer wall segment.

5. The roller and cage assembly of claim 1 wherein each retention tab extends from a respective inner wall segment.

6. The roller and cage assembly of claim 1 wherein the retention tabs alternatingly extend from the inner wall segments and the outer wall segments.

7. The roller and cage assembly of claim 1 wherein each retention tab includes an inward dimple configured to provide point contact with an end of a respective roller.

8. The roller and cage assembly of claim 7 wherein each dimple has an outward raised bead thereabout.

9. The roller and cage assembly of claim 1 wherein the base includes an outward dimple aligned with each roller pocket to provide point contact with an end of a respective roller.

10. The roller and cage assembly of claim 1 wherein each retention tab has a planar surface that extends substantially perpendicular to a respective inner or outer wall segment.

11. The roller and cage assembly of claim 1 wherein the retention tabs are formed from cutouts in the inner or outer wall segments.

12. The roller and cage assembly of claim 1 wherein the retention tabs provide continuous links between adjacent ones of the inner or outer wall segments.

13. The roller and cage assembly of claim 1 wherein a radial projection extends inward from one or more of the outer wall segments adjacent a respective outer opening.

14. The roller and cage assembly of claim 1 wherein a radial projection extends outward from one or more of the inner wall segments adjacent a respective inner opening.

15. A method of forming a roller and cage assembly comprising the steps of:
providing a flat sheet of a desired cage material;
stamping the flat sheet to define a base surface having an inner circumferential edge and an outer circumferential edge with a plurality of integral inner wall segments extending from the inner circumferential edge with an opening provided between adjacent inner wall segments, a plurality of integral outer wall segments extending from the outer circumferential edge with an opening provided between adjacent outer wall segments and a plurality of integral retention tabs extending from the inner or outer wall segments;
bending the inner and outer wall segments relative to the base surface such that the inner and outer wall segments extend substantially perpendicular to the base surface with the respective inner and outer openings aligned to define roller pockets positioned between the inner and outer wall segments;
positioning a plurality of rollers in the roller pockets; and
aligning the retention tabs such that the retention tabs extend opposite of the base and are aligned with the roller pockets such that the tabs axially retain the rollers.

16. The method of claim 15 further comprising the step of providing each retention tab with an inward dimple.

17. The method of claim 15 further comprising the step of providing the base surface with an outward dimple aligned with each roller pocket.

18. The method of claim 15 wherein the step of bending the inner and outer wall segments relative to the base surface utilizes a drawing process.
